(19) United States
(12) Patent Application Publication
(10) Pub. No.: US 2011/0216083 A1
(43) Pub. Date: Sep. 8, 2011

(54) SYSTEM, METHOD AND APPARATUS FOR CONTROLLING BRIGHTNESS OF A DEVICE

(75) Inventor: Matthew Blake McRae, Laguna Beach, CA (US)

(73) Assignee: VIZIO, INC., Irvine, CA (US)

(21) Appl. No.: 12/716,295

(22) Filed: Mar. 3, 2010

(51) Int. Cl. G09G 5/02

(52) U.S. Cl. 345/589

(57) ABSTRACT

An application for controlling the brightness of a display of a device includes having a first brightness setting and a second brightness setting, the first brightness setting is used to set the brightness of the display when two-dimensional content is displayed on the display while the second brightness setting is used to set the brightness of the display when three-dimensional content is displayed on the display. The first and second brightness settings are preferably administered through a user interface.

### FIELD

This invention relates to the field display systems such as televisions that reproduce both two-dimensional and three-dimensional content, and in particular, changing the brightness of the display based upon the content currently displayed.

### BACKGROUND

There are several ways to present a three-dimensional image to a viewer of a television. The common aspect of the existing methods is to present an image or frame from two perspectives, a left-eye perspective of the content to the left eye and present an image or frame from a right-eye perspective to the right eye. This creates the proper parallax so that the viewer sees both perspectives and interprets what they are seeing as three-dimensional.

Early three-dimensional content was captured using two separate cameras aimed at the subject but slightly separate from each other providing two different perspectives. This simulates what the left eye and right eye see. The cameras simultaneously exposed two films. Using three-dimensional eyewear, the viewer looks at one film with the left eye and the other film with the right eye, thereby seeing what looks like a three-dimensional image.

Progressing to motion pictures, three-dimensional movies were produced in a similar way with two side-by-side cameras, but the resulting images were color encoded into the final film or video. To watch the film in three-dimension, eyewear with colored filters in either eye separate the appropriate images by canceling out the filter color. This process is capable of presenting a three-dimensional movie simultaneously to a large audience, but has marginal quality and, because several colors are filtered from the content, results in poor color quality, similar to a black and white movie.

More recently, personal headsets have been made that have two separate miniature displays, one for each eye. In such, left content is presented on the display viewed by the left eye and right content is presented on the display viewed by the right eye. Such systems work well, but require a complete display system for each viewer.

Similar to this, Eclipse methods uses a common display, such as a television, along with personal eyewear that have fast-response shutters over each eye. In such, the left eye shutter is open allowing light to pass and the right eye shutter is closed blocking light while the television displays left-eye content, therefore permitting the light (image) from the television to reach the left eye. This is alternated with closing of the left eye shutter, opening of the right eye shutter and displaying right-eye content on the television. By alternating faster than the typical human perception time, the display appears continuous and flicker-free.

As the eyewear alternately shutters the left/right eye LCDS, each LCD shutter is open approximately half of the time and closed the other half of the time. Given a fixed brightness of the television, the effective brightness reaching the viewer's eyes is approximately half of the brightness. Given existing televisions, the viewer is certainly able to increase the brightness when three-dimensional content is displayed through standard user interfaces using a remote control and on-screen display, but this then requires the viewer to reset the brightness when reverting to viewing two-dimensional content. This is not practical when viewing a mix of two and three dimensional content such as a broadcast three-dimensional program having interspersed two-dimensional commercials.

What is needed is a system that will detect when three-dimensional content is displayed and automatically adjust the brightness to a first level when two-dimensional content is viewed and to a second level when three-dimensional content is viewed.

### SUMMARY

A device, such as a television, controls the brightness of a display using a first brightness setting and a second brightness setting. The device/television detects when two-dimensional content is displayed or when three-dimensional content is displayed. The first brightness setting is used to set the brightness of the display when two-dimensional content is displayed on the display while the second brightness setting is used to set the brightness of the display when three-dimensional content is displayed. The first and second brightness settings are preferably administered through a user interface.

In one embodiment, an automatic brightness control is disclosed including a display system having a display. The display system displays two-dimensional content during a first interval and three-dimensional content during a second interval. The display system determines when three-dimensional content is displayed. When two-dimensional content is displayed by the display system, the display system sets a brightness level of the display to a first brightness level and when three-dimensional content is displayed by the display system, the display system sets a brightness level of the display to a second brightness level.

In another embodiment, a method of automatically controlling the brightness of a display is disclosed including (a) receiving content and (b) determining if the content is two-dimensional content or three-dimensional content. (c) If the content is two-dimensional content, setting a brightness level of the display to a first brightness level and (d) if the content is three-dimensional content, setting the brightness level of the display to a second brightness level then (e) displaying the content and (f) repeating the steps a-f.

In another embodiment, a system for automatic control of brightness is disclosed including a television that has a display and a processor with software running on the processor that determines a type of content to be displayed (two-dimensional content or three-dimensional content). Additional software running on the processor sets a brightness level of the display to a first brightness level before displaying the two-dimensional content and sets the brightness level of the display to a second brightness level before displaying the three-dimensional content and the software running on the processor then displays the content on the display.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a level of brightness from a television/display reaching an eye of a viewer according to the prior art.

FIG. 2 illustrates a plan view of the same level of brightness from a television/display passing through an LCD shutter of three-dimensional eye wear reaching the eye of the viewer.

FIG. 3 illustrates a plan view of an increased level of brightness from the television/display passing through an LCD shutter of three-dimensional eye wear reaching the eye of the viewer.

FIG. 4 illustrates a first flow chart operating on a processor within the typical television.

FIG. 5 illustrates a second flow chart operating on the processor within the typical television.

FIG. 6 illustrates a chain of a typical user interface of a television/display.

FIG. 7 illustrates a block diagram of a typical television system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Referring to FIG. 1, a plan view of a level of brightness 12 from a television/display 5 reaching an eye of a viewer 20 according to the prior art will be described. Current display technology provides a brightness control to increase/decrease the brightness 12 coming from the display 5 for the comfort of the viewer 20. For example, the brightness of a television is controlled through an on-screen user interface as known in the industry. In some television/display 5 systems, a light sensor is employed (not shown) to detect ambient light and automatically adjust the brightness 12 of the television/display 5.

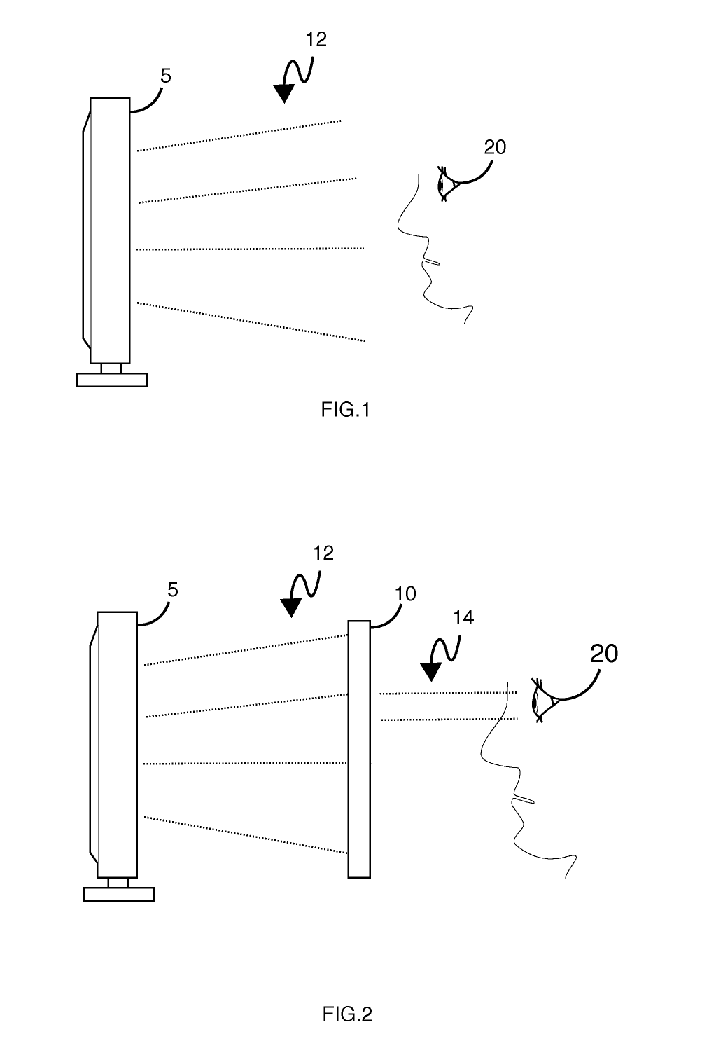

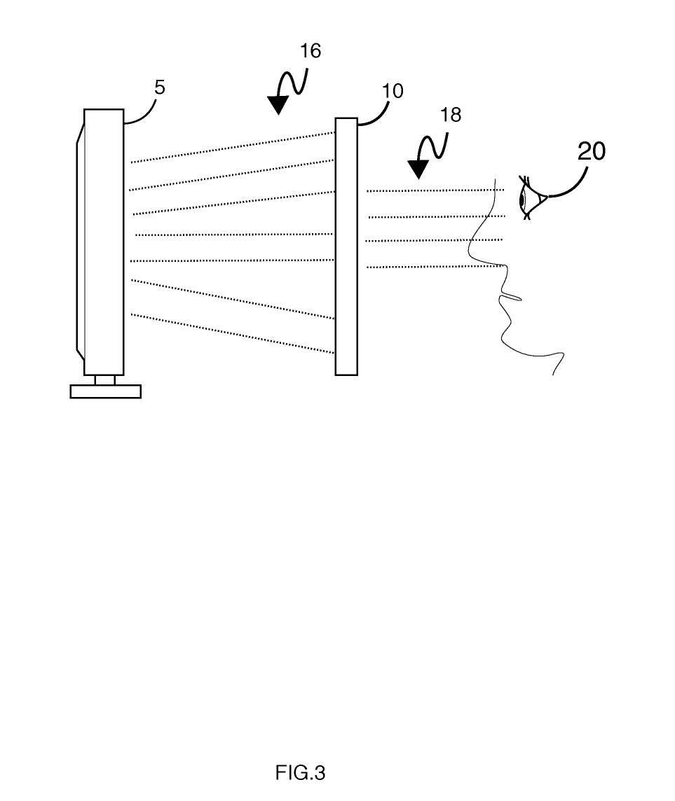

Referring to FIGS. 2 and 3, plan views of the same level of brightness 12 from the television/display 5 (FIG. 2) and an increased level of brightness 16 from the television/display 5 (FIG. 3) passing through an LCD shutter 10 of three-dimensional eye wear reaching the eye of the viewer 20 will be described. In three-dimensional eyewear, an LCD shutter 10 is positioned in front of each eye. When content for the left eye is displayed on the television/display 5, the left eye LCD shutter 10 is open, allowing light from the television through the shutter 10 to the left eye of the viewer 20 while the right eye shutter 10 is closed. When content for the right eye is displayed on the television/display 5, the right eye LCD shutter 10 is open, allowing light from the television through to the right eye of the viewer 20 while the left eye shutter 10 is closed. Since the left-eye content/right-eye content duty cycle is approximately 50 percent, the left eye LCD shutter 10 is open approximately 50% of the time and closed approximately 50% of the time. Likewise for the right eye LCD shutter 10. Since each shutter 10 is open approximately 50% of the time, approximately 50% of the light (brightness) 12 from the television/display 5 gets to the eyes of the viewer 20. Therefore, the viewer 20 realizes a much dimmer image from the television/display 5 as depicted by the decreased brightness 14 reaching the eye of the viewer 20.

To compensate for the decreased brightness 14, the viewer 20 controls the television/display 5 to increase the brightness to a higher level of brightness 16, resulting in a brightness or amount of light 18 similar to that viewed without the LCD shutters of FIG. 1. This provides the viewer 20 with the desired amount of brightness.

In such, the viewer 20 increases the brightness when watching three-dimensional content, then decreases the brightness when watching two-dimensional content (even while wearing the three-dimensional eyewear). This process is tedious, especially when content is mixed such as when two-dimensional commercials are inserted into a three-dimensional movies or show.

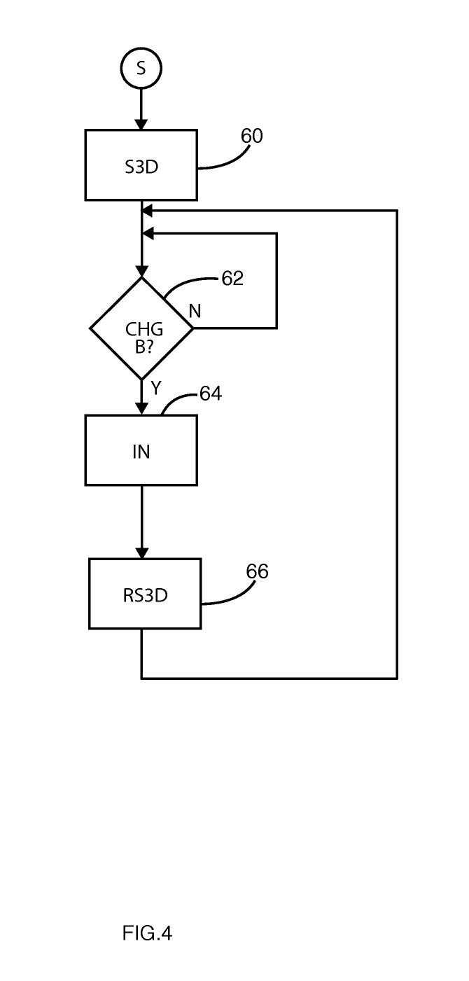

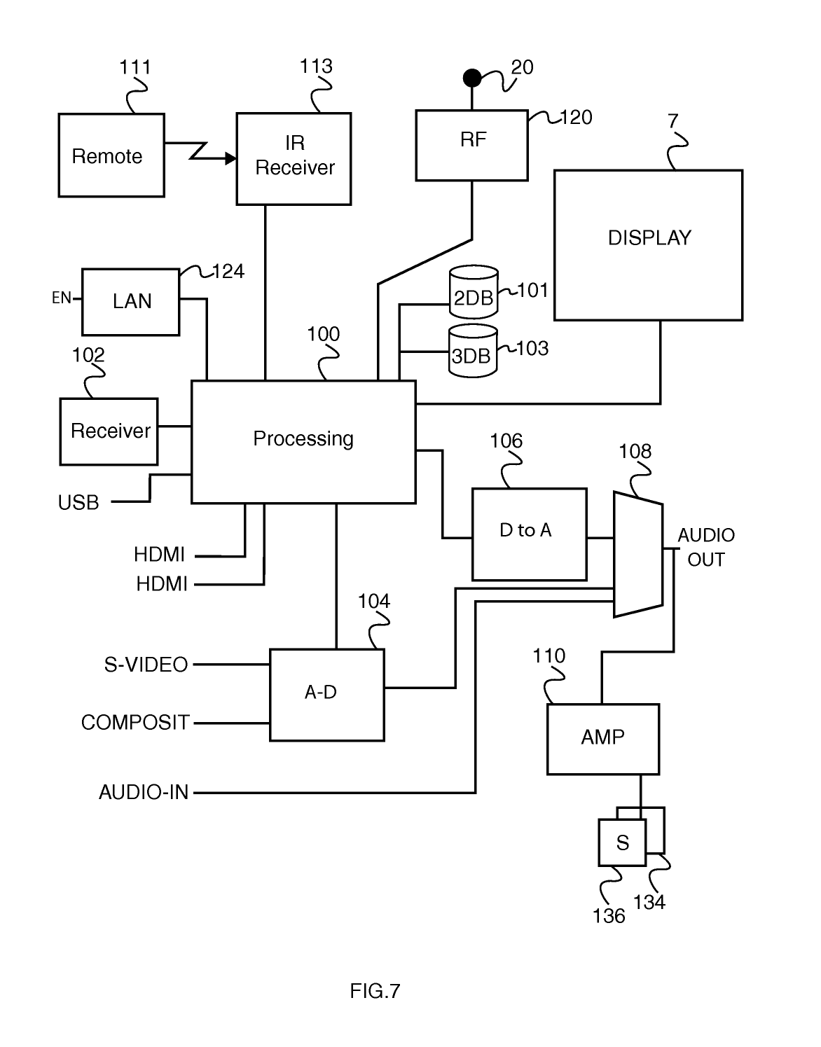

Referring to FIG. 4, a first flow chart operating on a processor 100 (see FIG. 7) within the typical television 5 will be described. In this exemplary television 5, there are at least two different brightness values stored such as a two-dimensional brightness value 101 (or standard brightness value) and a three-dimensional brightness value 103 (see FIG. 7). Each has a default brightness value and each is adjustable, for example, through a user interface. The flow of one typical brightness user interface starts with setting the three-dimensional brightness value 103 to an initial value 60 then waiting 62 for a request to change the brightness value 103 (for example, waiting until a user traverses a set of user interface menus by way of a remote control 111 to access the change-brightness menu—see FIG. 7). Next, the new brightness is inputted 64 (for example by signaling a slider to move left/right using the remote control 111) and the three-dimensional brightness value 103 is set to the new value 66.

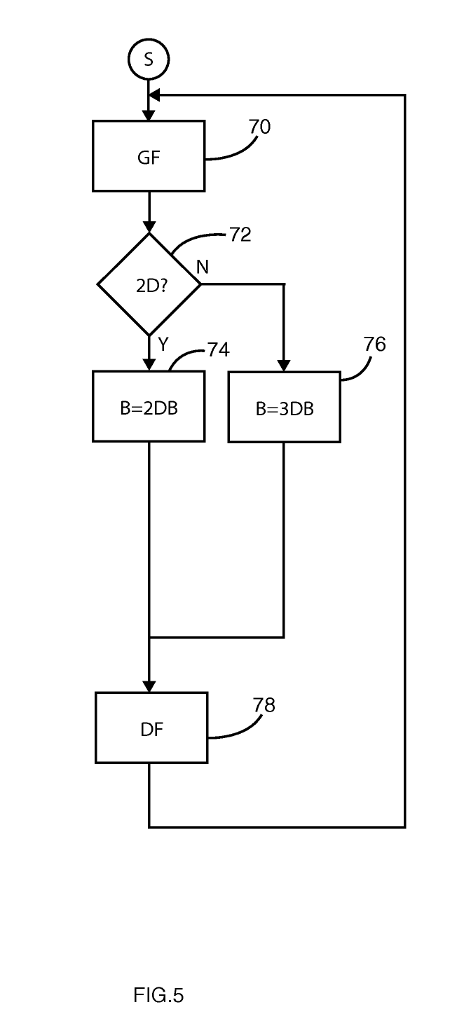

Referring to FIG. 5, a second flow chart operating on the processor 100 within the typical television 5 will be described. A processing element 100 within the television 5 decodes a video signal for display on a display 7 (see FIG. 7). The processing element 100 has information regarding the type of each frame that is displayed such as whether the current frame is a two-dimensional frame, a left-eye frame or a right-eye frame. Therefore, in this example, the processing element 100 knows when three-dimensional content is being displayed and, armed with such information, controls the brightness of the display 7. For example, the processing element 100 gets a frame for display 70. If the frame is a two-dimensional frame (e.g. both eye shutters are open or no eyewear is in use), the processing element sets 74 the brightness to the two-dimensional brightness value 101. If the frame is a three-dimensional frame (e.g. only one eye shutter is open at a given time), the processing element sets 76 the brightness to the three-dimensional brightness value 103. In either case, the frame is displayed 78 at which ever brightness value was selected.

In some embodiments, the processing element 100 does not know from the content whether the content is two-dimensional or three-dimensional. In such, the processing element communicates with the source (e.g. a Blueray player connected to an HDMI input or a Set Top Box connected to an HDMI input) to determine the type of content. In some embodiments, the processor queries an electronic program guide or Internet service to determine if the content is two-dimensional or three-dimensional. In this embodiment, it is possible for two-dimensional commercials to be intermixed with the three-dimensional content. It is anticipated that, in this embodiment, the processor 100 uses known detection schemes or heuristics to determine when a commercial is being displayed and reverts to the two-dimensional brightness during the commercial.

In some embodiments, the brightness is changed instantaneously from the two-dimensional brightness to the three-dimensional brightness and back immediately responsive to content changes while in other embodiments brightness is changed gradually from the two-dimensional brightness to the three-dimensional brightness and gradually back responsive to content changes.

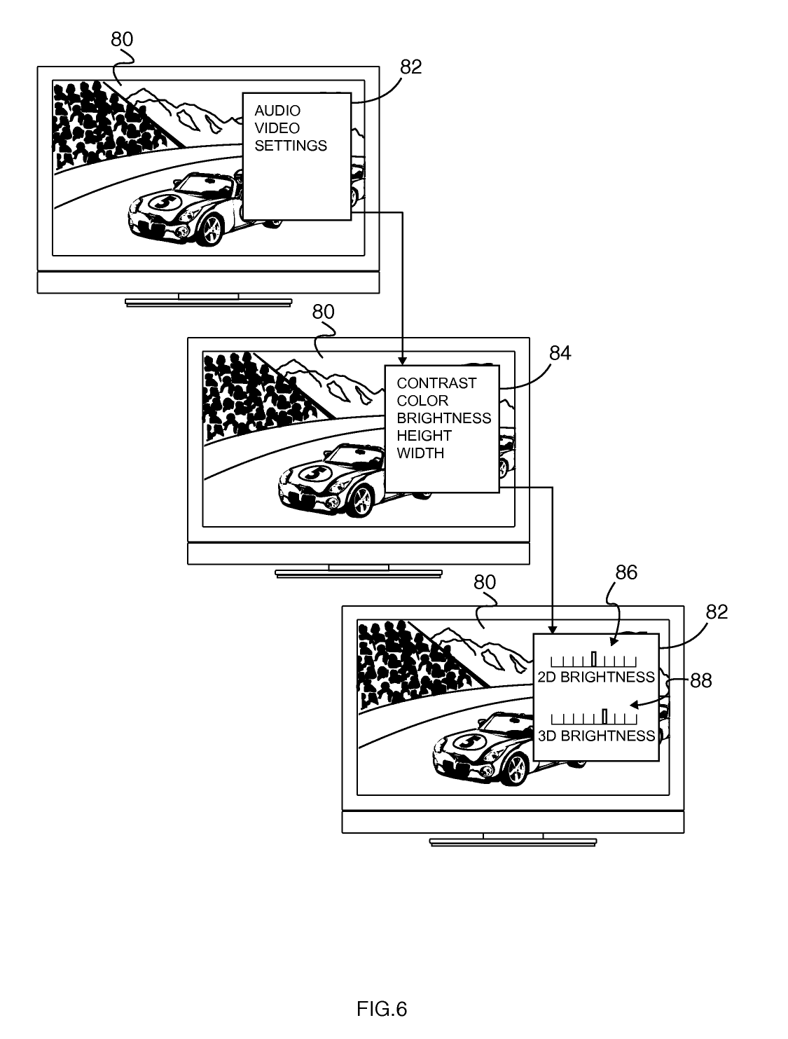

Referring to FIG. 6, a chain of a typical user interface of a television/display 5 will be described. It is anticipated that each brightness setting is preset to a factory default setting and a user interface is used to change the settings. The user interface of FIG. 6 is an exemplary user interface for setting the brightness settings. Normally, most user interfaces occupy a portion of the display 7 while content 80 is displayed using a pop-up, overlay, translucent menu, etc, as known in the industry.

The first user interface pop-up or overlay menu 82 is a main-menu having, for example, three selections (Audio, Video, Settings). The viewer 20 selects “Video” and the second menu 84 appears for adjusting video settings (Contrast, Color, Width, Height, and Brightness). The viewer 20 selects Brightness and a third menu appears with two sliders 86/88. The first slider 86 is the two-dimensional brightness slider 86 while the second slider 88 is the three-dimensional brightness slider 88. The viewer 20 uses functions of, for example, a remote control 111 to adjust one or both of the sliders 86/88 to the desired brightness then exits the menu. The changed values from the sliders 86/88 are stored in the two-dimensional brightness value 101 and the three-dimensional brightness value 103. The user interface of FIG. 6 is an example and many other user interface systems are known, all of which are included here within.

In some embodiments, the three-dimensional brightness value 103 is a set to a mathematical function of the two-dimensional brightness value 101. For example, the mathematical function is a linear multiplication of 1.7 and whenever the two-dimensional brightness value 101 is changed, the three-dimensional brightness value 103 is a set to 1.7 times the two-dimensional brightness value 101. For example, if the two-dimensional brightness value 101 is set to 50%, then the three-dimensional brightness value 103 is a set to 85%. Any mathematical function is anticipated including non-linear functions such that as the two-dimensional brightness value 101 approaches 100%, so does the three-dimensional brightness value 103 since it doesn't make sense for the three-dimensional brightness value 103 to be greater than 100%.

Referring to FIG. 7, a schematic view of an exemplary television will be described. This figure is intended as a representative schematic of a typical monitor/television 5 and in practice, some elements are not present in some monitors/televisions 5 and/or additional elements are present in some monitors/televisions 5 as known in the industry. In this example, a display panel 7 for content is connected to a processing element 100. The display panel 7 is representative of any known display panel including, but not limited to, LCD display panels, Plasma display panels, OLED display panels, LED display panels and cathode ray tubes (CRTs).

The processing element 100 accepts video inputs and audio inputs selectively from a variety of sources including an internal television broadcast receiver 102, High Definition Multimedia Interface (HDMI), USB ports and an analog-to-digital converter 104. The analog-to-digital converter 104 accepts analog inputs from legacy video sources such as S-Video and Composite video and converts the analog video signal into a digital video signal before passing it to the processing element. The processing element 100 controls the brightness of the display of the video on the display panel 7. It is anticipated, in some embodiments, the indications of two-dimensional or three-dimensional content is communicated to the television 5 over the HDMI.

Audio emanates from either the broadcast receiver 102, the legacy source (e.g., S-Video) or a discrete analog audio input (Audio-IN). If the audio source is digital, the processing element 100 routes the audio to a digital-to-analog converter 106 and then to an input of a multiplexer 108. The multiplexer 108, under control of the processing element 100, selects one of the audio sources and routes the selected audio to the audio output and an internal audio amplifier 110. The internal audio amplifier 110 amplifies the audio and delivers it to internal speakers 134/136.

The processing element 100 accepts commands from a remote control 111 through remote receiver 113. Although IR is often used to communicate commands from the remote control 111 to the remote receiver 113, any known wireless technology is anticipated for connecting the remote control 111 to the processing element 100 including, but not limited to, radio frequencies (e.g., Bluetooth), sound (e.g., ultrasonic) and other spectrums of light. Furthermore, it is anticipated that the wireless technology be either one way from the remote 111 to the receiver 113 or two way.

In this exemplary television, the processing element 100 has local, persistent storage (e.g. flash memory, hard disk, etc) for storing and accessing, for example, the two-dimensional brightness value 101 and the three-dimensional brightness value 103.

In some embodiments, the television 5 connects to networks through a wireless network interface 120 having an antenna 20. In some embodiments, the television connects to a local area network using a local area network adapter 124 for connecting to, for example, an Ethernet local area network or a power line local area network, as known in the industry. In some embodiments, the processor 100 communicates to an Internet-based service through the wireless network interface 120 or the local area network 124 to determine when two-dimensional or three-dimensional content is being displayed.

Equivalent elements can be substituted for the ones set forth above such that they perform in substantially the same manner in substantially the same way for achieving substantially the same result.

It is believed that the system and method and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An automatic brightness control comprising:
a display system having a display, the display system displaying two-dimensional content during a first interval and three-dimensional content during a second interval;
a means for determining when the three-dimensional content is displayed by the display system;
when the two-dimensional content is displayed by the display system, setting a brightness level of the display to a first brightness level; and
when the three-dimensional content is displayed by the display system, setting the brightness level of the display to a second brightness level.

2. The automatic brightness control of claim 1, further comprising a means for setting the first brightness level.

3. The automatic brightness control of claim 1, further comprising a means for setting the second brightness level.

4. The automatic brightness control of claim 2, wherein the second brightness level is changed to a mathematical function of the first brightness level responsive to the means for setting the first brightness level.

5. The automatic brightness control of claim 1, wherein the means for determining when the three-dimensional content is displayed extracts an indication of content-type from the content.

6. The automatic brightness control of claim 1, wherein the means for determining when the three-dimensional content is displayed consults an electronic program guide to determine when the three-dimensional content is being displayed.

7. The automatic brightness control of claim 1, wherein the means for determining when the three-dimensional content is displayed accesses an Internet application to determine when the three-dimensional content is being displayed.

8. A method of automatically controlling the brightness of a display comprising:
(a) receiving content;
(b) determining if the content is two-dimensional content or three-dimensional content;
(c) if the content is the two-dimensional content, setting a brightness level of the display to a first brightness level;
(d) if the content is the three-dimensional content, setting the brightness level of the display to a second brightness level;
(e) displaying the content; and
(f) repeating steps a-f.

9. The method of claim 8, further comprising:
responsive to a user interface, changing the first brightness level.

10. The method of claim 8, further comprising:
responsive to a user interface, changing the second brightness level.

11. The method of claim 9, further comprising:
changing the second brightness level based on a mathematical function of the first brightness level.

12. The method of claim 8, wherein the determining of when the three-dimensional content is displayed uses an indication of content-type from the content.

13. The method of claim 8, wherein the determining of when the three-dimensional content is displayed consults an electronic program guide to determine when the three-dimensional content is being displayed.

14. The method of claim 8, wherein the determining of when the three-dimensional content is displayed uses an Internet application to determine when the three-dimensional content is being displayed.

15. A system for automatic control of brightness comprising:
a television comprising a display and a processor;
software running on the processor determines a type of content to be displayed selected from the group consisting of two-dimensional content and three-dimensional content;
software running on the processor sets a brightness level of the display to a first brightness level before displaying the two-dimensional content;
software running on the processor sets the brightness level of the display to a second brightness level before displaying the three-dimensional content; and
software running on the processor displays the content on the display.

16. The system for automatic control of brightness of claim 15, further comprising software running on the processor that sets the first brightness level responsive to an input from a viewer.

17. The system for automatic control of brightness of claim 15, further comprising software running on the processor that sets the second brightness level responsive to an input from a viewer.

18. The system for automatic control of brightness of claim 16, further comprising software running on the processor that changes the second brightness level to a mathematical function of the first brightness level responsive to the input from the viewer.

19. The system for automatic control of brightness of claim 15, wherein the software running on the processor determines the type of content to be displayed using an indication of content-type from the content.

20. The system for automatic control of brightness of claim 15, wherein the software running on the processor determines a type of content to be displayed consults an electronic program guide to determine when the three-dimensional content is being displayed.
